(19) United States
(12) Patent Application Publication
(10) Pub. No.: US 2008/0293024 A1
(43) Pub. Date: Nov. 27, 2008

(54) Educational buckle toy

(76) Inventors: Emily Elizabeth Ross, Chapel Hill, NC (US); Jane Hope Ross, Pittsboro, NC (US)

Correspondence Address: Neagle Law Firm, PC, 605 W. Main Street, Suite 104, Carrboro, NC, 27510, US

(21) Appl. No.: 12/079,831

(22) Filed: Mar. 28, 2008

Related U.S. Application Data
(60) Provisional application No. 60/940,226, filed on May 25, 2007.

(51) Int. Cl. G09B 19/00

(52) U.S. Cl. 434/260

(57) ABSTRACT

An educational toy comprising a body and a plurality of belts affixed thereto. Each of the plurality of belts is comprised of a pair of ribbons, each pair of ribbons having a first ribbon coupled to a first cooperating buckle member, and a second ribbon coupled to a second cooperating buckle member. The first cooperating buckle member and the second ribbon coupled are releasably attachable one to the other. Each pair of ribbons has unique matching indicia that differ from every other pair of ribbons. The present invention allows the first cooperating buckle member to be associated with the second cooperating buckle member by correlating the unique matching indicia thus providing visual cues that enhance and stimulate buckling and unbuckling skills. A combination of buckle type, buckle shape and buckle color provide additional visual cues.

### CROSS-REFERENCE TO RELATED APPLICATIONS

This application claims the benefit of Provision Patent Application Ser. No. 60/940,226, filed May 25, 2007.

### BACKGROUND OF INVENTION

1. Field of Invention

The present invention relates to an educational toy, and more particularly to a toy that facilitates developmental skills associated with buckling and unbuckling.

2. Relevant Background

From the time children are born, they are buckled in and out of car seats, bouncy seats, rockers, swings, baby back carriers, high chairs and various other objects that utilize securing devices, many of which are safety harnesses that utilize buckles. Children's natural curiosity and need for tactile, visual and oral stimulation encourages them to explore buckles long before they have any understanding of their function and working mechanism. The ability to buckle and unbuckle requires specific motor skills, an understanding of cause and effect, and the ability to match like shapes and colored units. It is important that a child be allowed to learn buckling and unbuckling skills by imitating, exploring and eventually mastering a constant in their environment,

It is, therefore, desirable to provide an improved toy which facilitates development skills for buckling and unbuckling in order to overcome most, if not all, of the preceding problems.

### SUMMARY

The present invention is directed to an educational toy that is geared substantially toward children who have begun to gain some small motor control and can manipulate two pieces of a buckle. The present invention allows children to associate buckle pieces by pairs of ribbons attached thereto, each pair of ribbons having unique matching indicia that provide a visual cue for matching the pieces of the buckle often before children are able to match buckle pieces by size and shape. The visual process of matching, the manipulative aspect of the toy, the attention to the motor requirement aspect of the toy, and the problem-solving aspect of the task will engage the child for stretches of time, enhancing their attention and concentration. The toy will ‘grow’ with the child as unbuckling depends on more advanced development and motor skills, thus adding to the longevity and usefulness of the toy.

The present invention comprises a body and a plurality of belts, each of the plurality of belts being capable of extending around a periphery of the body. In the preferred embodiment, the body is an elongated member that has a shape of a torso of an animal such as without limitation the shape of a torso of a bear, a torso of a dog, a torso of a cat, and a torso of a bunny. In other embodiments, the body has a shape of an inanimate object such as without limitation a shape of a cube, a shape of a round ball, and a shape of a football. It is to be understood that the body may have any shape that is capable of serving its intended purpose of allowing the plurality of belts extend around a periphery of the body and be secured thereto.

In the preferred embodiment, the body comprises a body stuffing such as cotton encased within a body skin. The body skin may be made from fabric such as without limitation velboa fabric and non-pilling fleece. One skilled in the art will recognize that there are various materials that may be used for the body stuffing and various materials from which the body skin may be made. In the preferred embodiment, the body has a width of approximately 25 cm (approximately 10 inches).

In the preferred embodiment, each of the plurality of belts comprises a pair of ribbons and a buckle. Each pair of ribbons may comprise a first ribbon having a first ribbon connecting end at one end and a first ribbon buckle end at an opposite end, and a second ribbon having a second ribbon connecting end at one end and a second ribbon buckle end at an opposite end.

In the preferred embodiment, the first ribbon connecting ends are permanently attached to the body, and may be vertically aligned one to the other, and horizontally spaced substantially the same distance one from the other. The second ribbon connecting ends are permanently attached to the body, and may be vertically aligned one to the other, and horizontally spaced one from the other. In alternate embodiments, the first ribbon connecting ends and the second ribbon connecting ends are releasably attached to the body. One skilled in the art will recognize that there are many suitable methods known in the art for attaching the first ribbon connecting ends and second ribbon connecting ends to the body.

In the preferred embodiment, the first ribbon connecting end and the second ribbon connecting end are non-specifically positioned in relation to each other such that the first ribbon connecting end and the second ribbon connecting end may be horizontally oriented one to the other and, alternatively, cross-configured one to the other. It is to be understood that there are numerous positional combinations available.

In an alternative embodiment, the body has one or more seams with a plurality of body sections extending between each of said one or more seams. Each first ribbon connecting end is attached to one of the one or more seams, and each second ribbon connecting end is attached to one of the one or more seams.

In the preferred embodiment each pair of ribbons may be made of grosgrain. In alternative embodiments, each pair of ribbons may be made of any other material capable of performing its intended purposes of attaching to the body and wrapping around the body.

In the preferred embodiment, the buckle may comprise a first cooperating buckle member and a second cooperating buckle member. The first cooperating buckle member may have a first cooperating buckle end that is attached to the first ribbon buckle end, and a first cooperating matching end at an opposite end. The second cooperating buckle member may have a second cooperating buckle end that is attached to the second ribbon buckle end, and a second cooperating matching end at an opposite end. The first cooperating buckle member and the second cooperating buckle member are releasably attachable one to the other, with the first ribbon and the second ribbon forming a periphery about the body when the first cooperating buckle member and said second cooperating buckle member are attached.

In the preferred embodiment, each of the pair of ribbons has unique matching indicia such that the first ribbon may be visually associated with the second ribbon. The unique matching indicia may be different for each pair of ribbons such that each of the pair of ribbons is distinguishable one from the other thus correlating the first ribbon and the second ribbon one to the other, thereby providing visual cues that assist children in matching the first cooperating buckle member with the second cooperating buckle member, thus enhancing and stimulating buckling and unbuckling skills.

In the preferred embodiment, the unique matching indicia consist of a common ribbon pattern such as straight vertical line patterns, wavy vertical lines, straight horizontal line patterns, wavy horizontal lines and polka dot patterns. In alternate embodiments, the unique matching indicia may consist of a common ribbon color, common ribbon widths, and common themes such as matching words of the same language, matching words from one or more languages that have substantially similar meanings, and matching words from one or more languages that are part of a phrase. It is to be understood that the unique matching indicia may be any indicia capable of distinguishing each of the pair of ribbons one from the other. One skilled in that will recognize that there are various indicia configurations available.

In one embodiment, each of the buckles may have a buckle color that is visually distinguishable one from the other. In alternative embodiments, two or more of the buckles have substantially similar buckle colors such that two or more of the buckles are visually indistinguishable from each other by buckle color. One skilled in the art will recognize that there are various colors for buckles.

In one embodiment, each of the buckles may have a buckle shape that is visually distinguishable one from the other. In alternative embodiments, two or more of the buckles have substantially similar buckle shapes such that two or more of the buckles are visually indistinguishable from each other by buckle shape. One skilled in the art will recognize that there are various shapes for buckles.

In one embodiment, each of the buckles may be of a different buckle type such as an insert buckle type, a side release buckle type, a parachute buckle, a lift latch buckle and a push button buckle type, thus making each of buckles visually distinguishable one from the other. In alternative embodiments, two or more of the buckles are of substantially similar buckle types thus making two or more of the buckles visually indistinguishable one from the other by buckle type. One skilled in the art will recognize that there are various types of buckles available.

In an alternative embodiment, each of the belts is distinguishable one from the other by a combination of buckle color, buckle type and buckle shape thereby providing additional visual cues that assist children in matching the first cooperating buckle member with the second cooperating buckle member.

In the preferred embodiment, each of the buckles is made of plastic. One skilled in the art will recognize that various materials can be used to make buckles.

In alternative embodiments, one or more of said plurality of belts is of sufficient length such that at least one of said pair of ribbons is capable of extending on at least two distinct peripheries of the body when the first cooperating buckle member is attached to the second cooperating buckle member.

In the preferred embodiment, the body has a head member attached thereto. The head member may comprise a head stuffing encased in a head skin. The head member may be substantially circular in shape. In an alternative embodiment, the head member may be triangular in shape. In the preferred embodiment, the head member has a face portion that resembles the face of an animal. The face portion may be embroidered and may comprise one or more eye members, a nose member, a mouth member, and one or more ear members. The nose member may be a plastic member covered by fabric. One skilled in the art will recognize that there are various shapes for heads and various methods for constructing a face portion. In the preferred embodiment, the widest portion of the head member is about 25 cm (approximately 10 inches), and the height of the head member may be about 18 cm (approximately 7 inches).

In the preferred embodiment, the head member contains a motion activated audio feedback device such that movement of the head member causes a sound to be emitted. In the preferred embodiment, the motion activated audio feedback device is a moveable clapper surrounded by metal rods encased in a plastic shell that emits a chime sound. In alternative embodiments, the motion activated audio feedback device emits a bell sound. One skilled in the art will recognize there are various ways to construct a motion activated feedback device suitable of performing its intended purpose of emitting a sound when movement is detected, and various ways to construct a motion activated feedback device that emits a variety of sounds.

The body may have one or more arm members affixed thereto. Each of the arm members may comprise an arm stuffing encased in an arm skin. In the preferred embodiment, there are two arm members. In the preferred embodiment, each of the one or more arm members is about 10 cm (approximately 4 inches) in length.

The body may have one or more leg members affixed thereto. Each of the leg members may comprise a leg stuffing encased in a leg skin. In the preferred embodiment, there are two leg members. In the preferred embodiment, each of the one or more leg members is about 5 cm (approximately 2 inches) in length.

In the preferred embodiment, the body has a tail member attached thereto. In alternative embodiments, the head member has whisker members attached thereto. The whisker members may be embroidered, or made from fishing line, yarn, horsehair, thread, or any material capable of serving its intended purpose of attaching to the head member and resembling whiskers of an animal such as without limitation a cat.

The applicant intends to encompass within the language any structure presently existing or developed in the future that performs the same function. In the claims, any means-plus-function clause is intended to cover the structures described herein as performing the recited function and, not only structural equivalents, but also equivalent structures. Other substitutions, modifications, changes and/or omissions may be made in the design, operating conditions and arrangement of the preferred and other exemplary embodiments without departing from the spirit of the present invention.

It is to be understood that the optimum dimensional relationships for the parts of the present invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

### REFERENCE NUMBERS IN THE DRAWINGS

# Description
20 Body
27 One or more seams
28 Plurality of body sections
40 Head member
48 Face portion
50 Eye members
52 Nose member
54 Mouth member
56 Ear members
60 Arm members
66 Motion activated audio feedback device
70 Leg members
76 Tail member
78 Whisker members
80 Belts
82 Pair of ribbons
84 First ribbon
86 First ribbon connecting end
88 First ribbon buckle end
94 Second ribbon
96 Second ribbon connecting end
98 Second ribbon buckle end
100 Buckles
102 First cooperating buckle member
104 First cooperating buckle end
106 First cooperating matching end
112 Second cooperating buckle member
114 Second cooperating buckle end
116 Second cooperating matching end

### BRIEF DESCRIPTION OF THE DRAWINGS

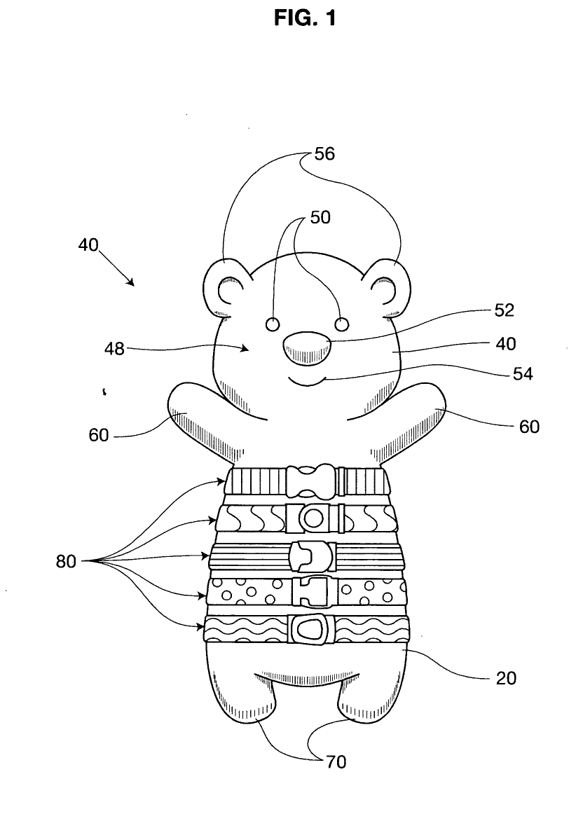

FIG. 1 is a front perspective view of the educational toy showing a body with a shape of a torso of a bear and five buckles with unique indicia of common ribbon patterns in accordance with one embodiment of the present invention.

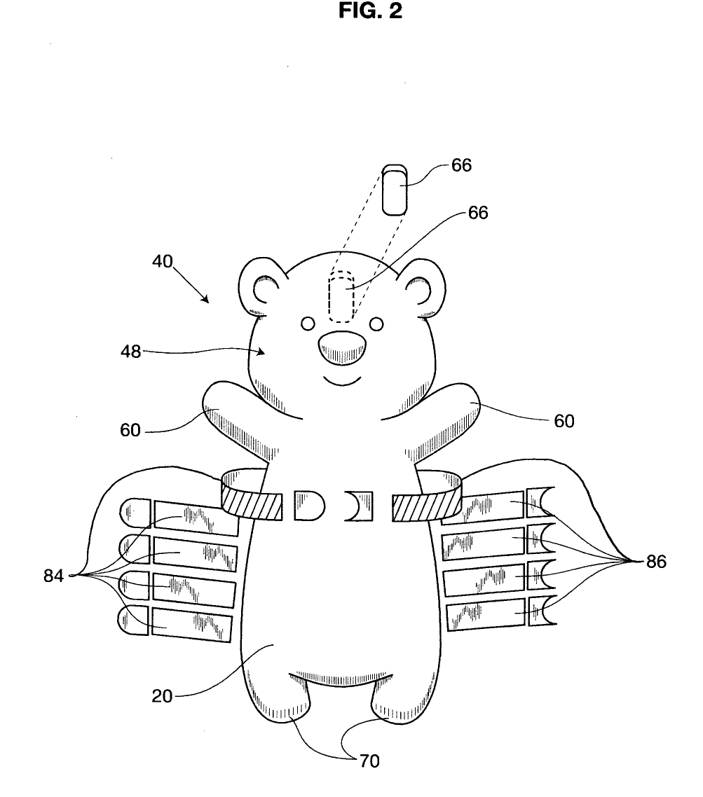

FIG. 2 is a perspective exploded view of the educational toy of FIG. 1 showing a motion activated audio feedback device.

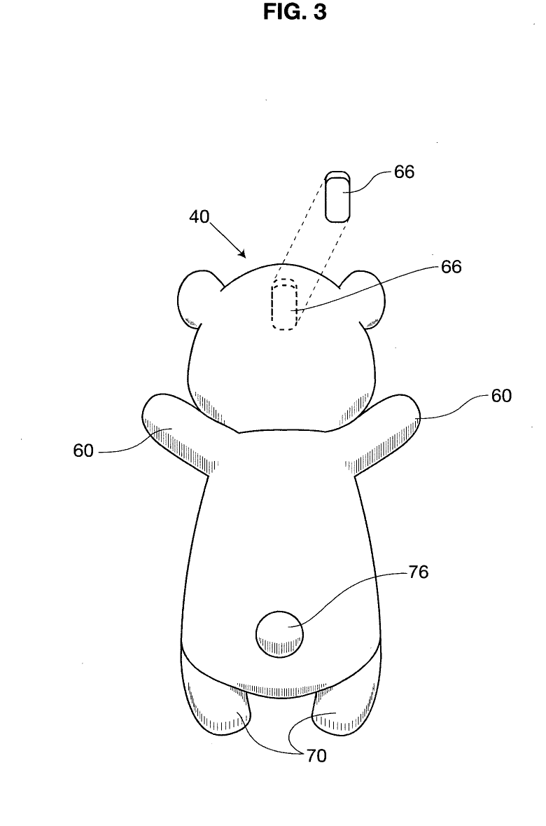

FIG. 3 is a back perspective view of the educational toy of FIG. 1 showing a motion activated audio feedback device.

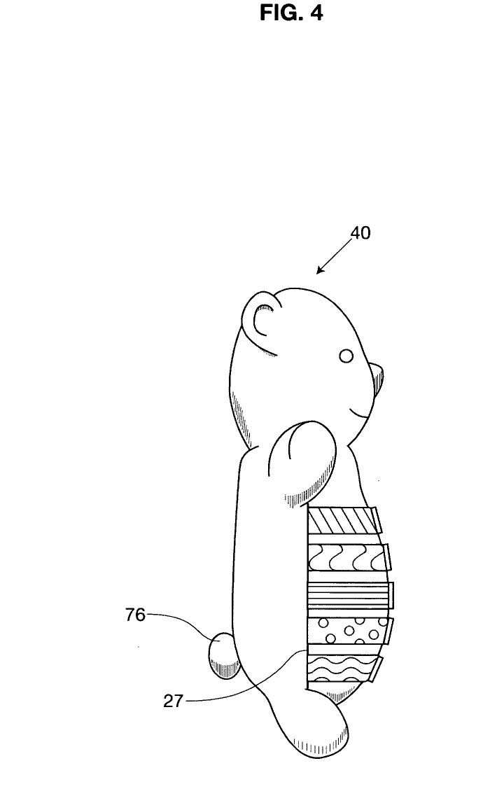

FIG. 4 is a first side perspective view of the educational toy of FIG. 1.

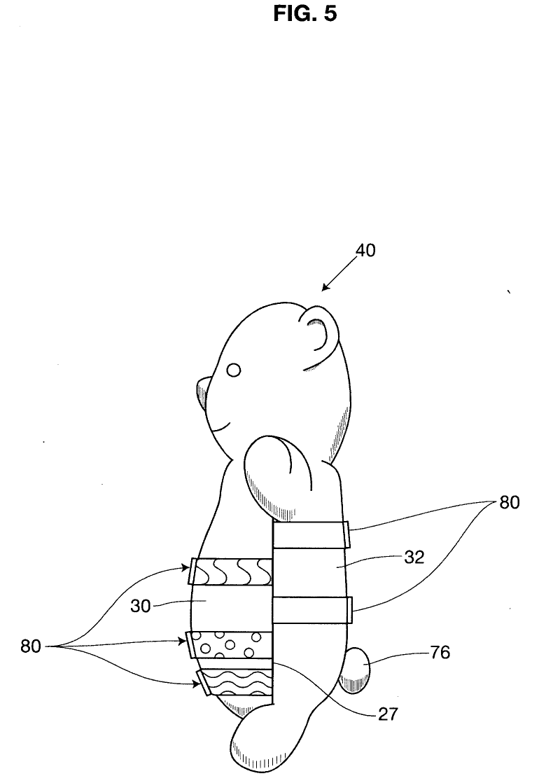

FIG. 5 is a second side perspective view of the educational toy showing a plurality of belts wrapped around at least two distinct peripheries of the body.

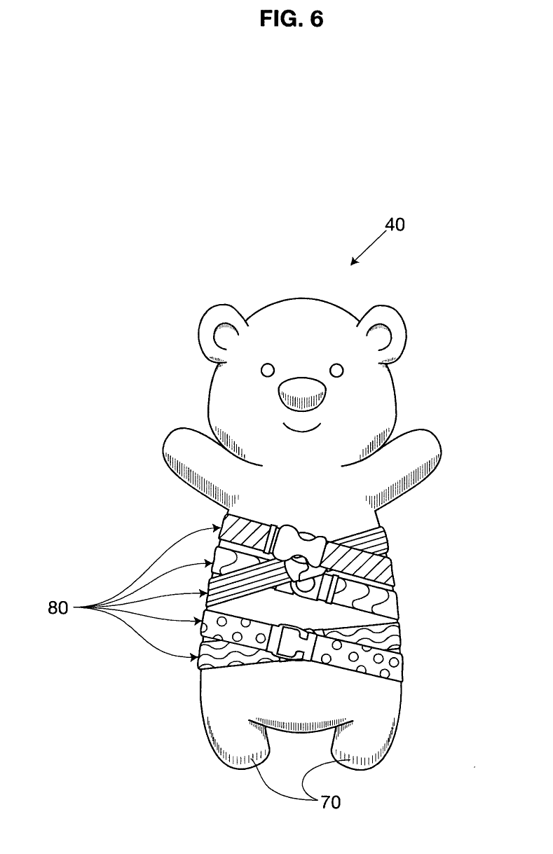

FIG. 6 is a front perspective view of the body of the educational toy showing each pair of ribbons cross-configured one to the other, and each pair of ribbons distinguishable one from the other by a combination of buckle types, buckle shapes and buckle colors.

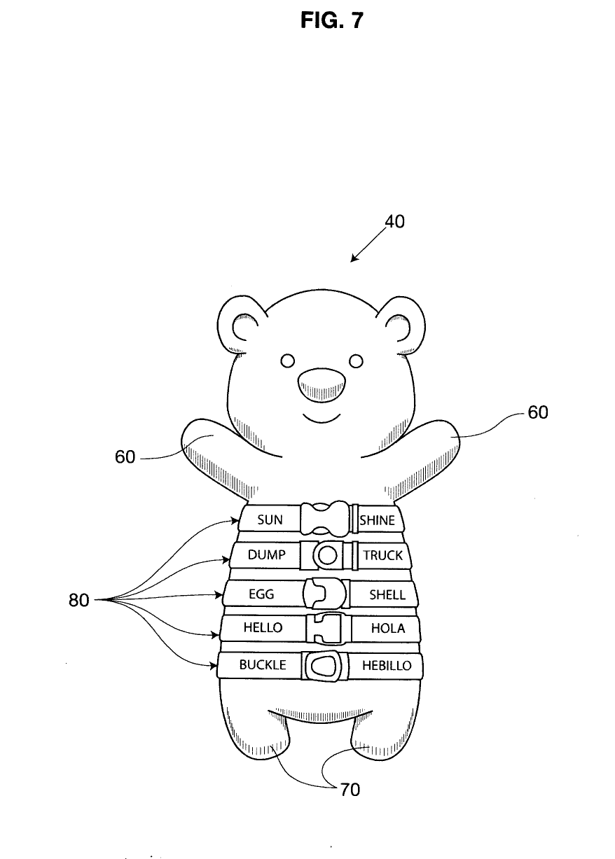

FIG. 7 is a front perspective view of the educational toy of FIG. 1 wherein each pair of ribbons has unique matching indicia of a common theme such that some pairs of ribbons have matching words that are the same language and some pairs of ribbons have matching words from one or more languages that have substantially similar meanings.

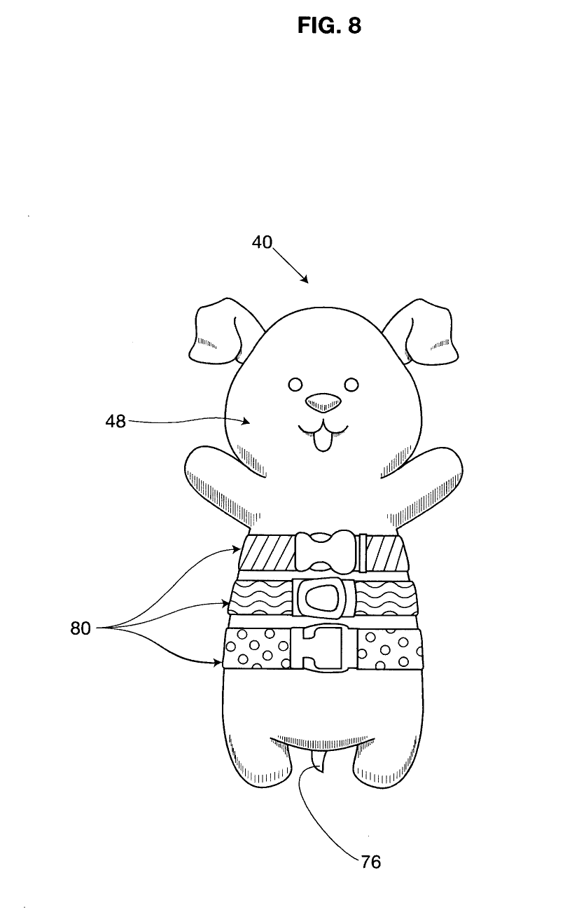

FIG. 8 is a front perspective view of the educational toy showing a dog with a tail and the body having three belts.

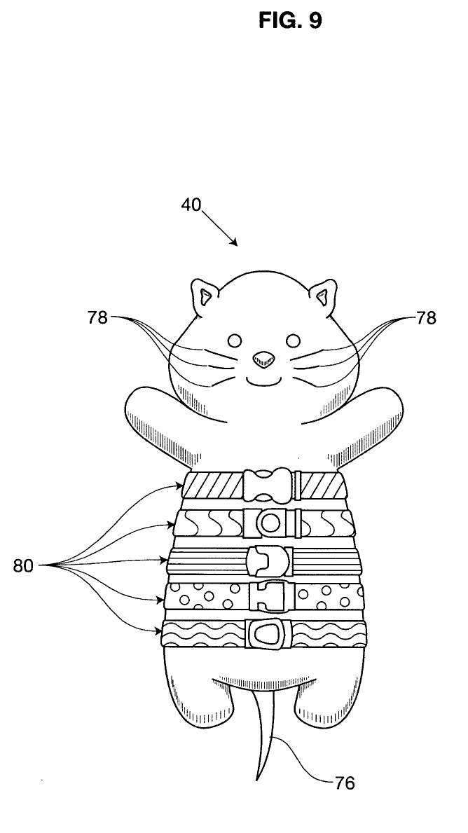

FIG. 9 is a front perspective view of the educational toy showing a cat with a tail member and whisker members.

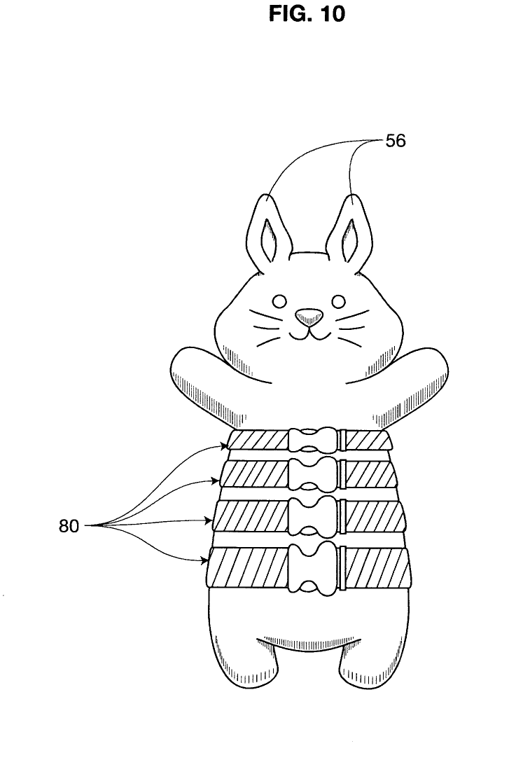

FIG. 10 is a front perspective view of the educational toy showing a bunny with unique matching indicia of common ribbon widths.

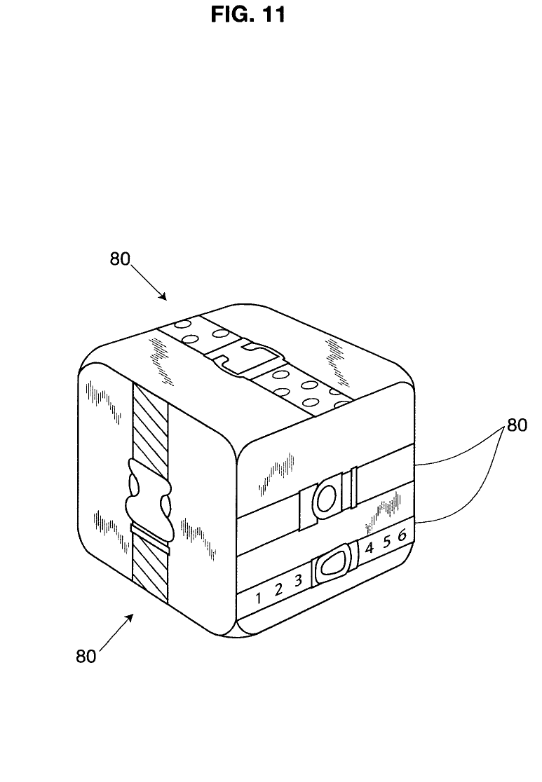

FIG. 11 is a front perspective view of the educational toy having a body with a shape of a cube and four belts attached thereto.

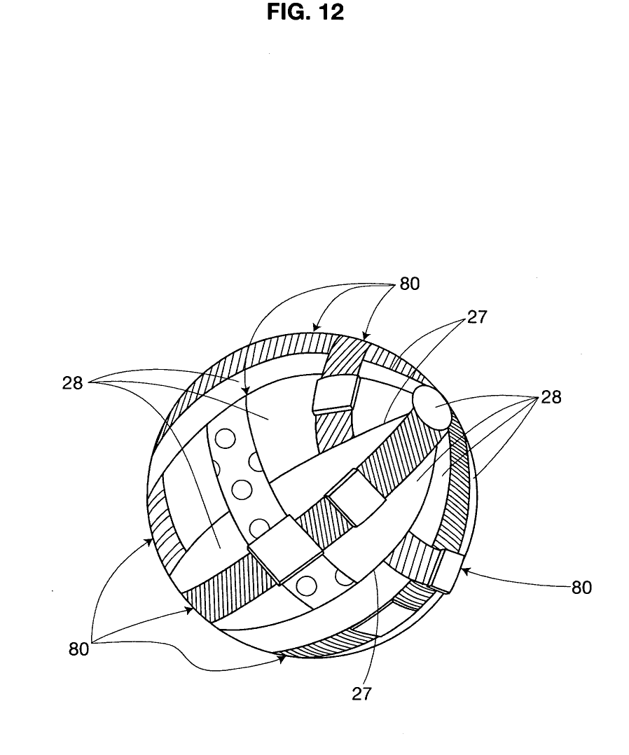

FIG. 12 is a front perspective view of the educational toy having a shape of a round ball.

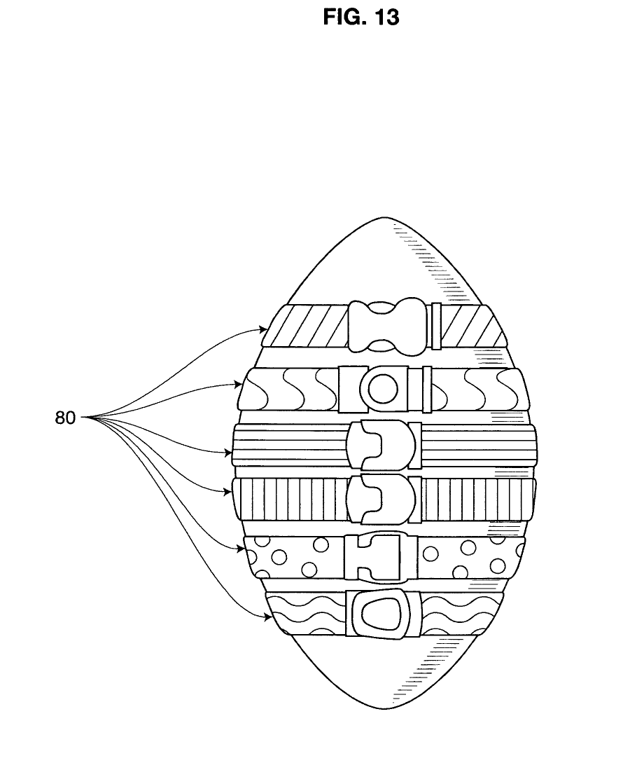

FIG. 13 is a front perspective view of the educational toy having a body with a shape of a football and six belts attached thereto.

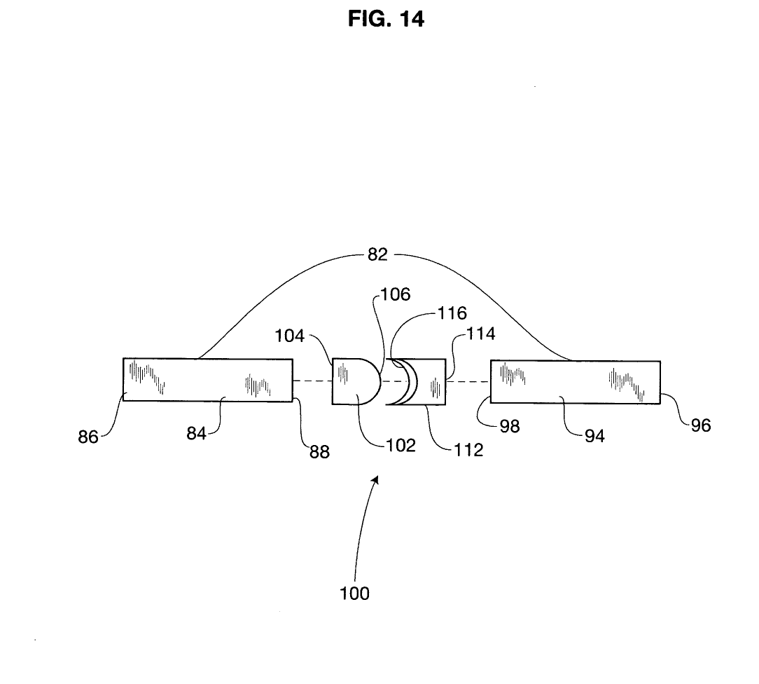

FIG. 14 is an exploded view of the belt of the educational toy.

It is to be understood that the present invention is not limited in its application to the details of the construction and arrangement of parts illustrated in the accompanying drawing, since the invention is capable of other embodiments and of being practiced or carried out in various ways within the scope of the present invention. For example, a plurality of materials of construction may be employed, both currently known or that later become known. It is to be understood that the present invention includes construction utilizing metric measurements. Also, it is also to be understood that the phraseology and terminology employed herein is for the purpose of description, and not of limitation.

### DETAILED DESCRIPTION

The present invention comprises a body 20 and a plurality of belts 80, each of the plurality of belts 80 being capable of extending around a periphery of the body 20.

In the preferred embodiment, the body 20 is an elongated member that has a shape of a torso of an animal. For example, FIGS. 1 through 7 show the body 20 resembling a torso of a bear. FIG. 8 shows the body 20 resembling a torso of a dog. FIG. 9 shows the body 20 resembling a torso of a cat. FIG. 10 shows the body 20 resembling a torso of a bunny. In other embodiments, the body 20 has a shape of an inanimate object. For example, FIG. 11 shows the body 20 having a shape of a cube. FIG. 12 shows the body 20 having a shape of a round ball. FIG. 13 shows the body 20 having a shape of a football. It is to be understood that the body 20 may have any shape that is capable of serving its intended purpose of allowing the plurality of belts 80 to extend around the periphery of the body 20 and be secured thereto.

In the preferred embodiment, the body 20 comprises a body stuffing such as cotton encased within a body skin, and the body skin is made from fabric such as without limitation Velboa fabric and non-pilling fleece. One skilled in the art will recognize that there are various materials that may be used for the body stuffing and various materials from which the body skin may be made. In the preferred embodiment, the body 20 may have a width of approximately 25 cm (approximately 10 inches).

In the preferred embodiment, as best shown in FIG. 14, each of the plurality of belts 80 comprises a pair of ribbons 82 and a buckle 100. Each pair of ribbons 82 may comprise a first ribbon 84 having a first ribbon connecting end 86 at one end and a first ribbon buckle end 88 at an opposite end, and a second ribbon 94 having a second ribbon connecting end 96 at one end and a second ribbon buckle end 98 at an opposite end.

In the preferred embodiment, as best shown in FIG. 4 and FIG. 5, the first ribbon connecting ends 86 are permanently attached to the body 20, and may be vertically aligned one to the other, and horizontally spaced substantially the same distance one from the other. The second ribbon connecting ends 96 are permanently attached to the body 20, and may be vertically aligned one to the other, and horizontally spaced one from the other. In alternate embodiments, the first ribbon connecting ends 86 and the second ribbon connecting ends 96 are releasably attachable to the body. One skilled in the art will recognize that there are many suitable methods known in the art for attaching the first ribbon connecting ends 86 and second ribbon connecting ends 96 to the body 20.

In the preferred embodiment, the first ribbon connecting end 86 and the second ribbon connecting end 96 are non-specifically positioned in relation to each other such that the first ribbon connecting end 86 and the second ribbon connecting end 96 may be horizontally oriented one to the other (shown in FIG. 1), and alternatively cross-configured one to the other (shown in FIG. 6). It is to be understood that there are numerous positional combinations available.

In an alternative embodiment, as best shown in FIG. 12, the body 20 has one or more seams 27 with a plurality of body sections 28 extending between each of the one or more seams 27. Each first ribbon connecting end 86 is attached to one of said one or more seams 27, and each second ribbon connecting end 96 is attached to one of said one or more seams 27.

In the preferred embodiment each pair of ribbons 82 may be made of grosgrain. In alternative embodiments, each pair of ribbons 82 may be made of any other material capable of performing its intended purposes of attaching to the body 20 and wrapping around the body 20.

In the preferred embodiment, as best shown in FIG. 14, the buckle 100 may comprise a first cooperating buckle member 102 and a second cooperating buckle member 112. The first cooperating buckle member 102 may have a first cooperating buckle end 104 that is attached to the first ribbon buckle end 88, and a first cooperating matching end 106 at an opposite end. The second cooperating buckle member 112 may have a second cooperating buckle end 114 that is attached to the second ribbon buckle end 98, and a second cooperating matching end 116 at an opposite end. The first cooperating buckle member 102 and the second cooperating buckle member 112 are releasably attachable one to the other, with the first ribbon 84 and the second ribbon 94 forming a periphery about the body 20 when the first cooperating buckle member 102 and said second cooperating buckle member 112 are attached one to the other.

In the preferred embodiment, each of the pair of ribbons 82 has unique matching indicia such that the first ribbon 84 may be visually associated with the second ribbon 86. The unique matching indicia may be different for each pair of ribbons 82 such that each of the pair of ribbons 82 is distinguishable one from the other thus correlating the first ribbon 84 and the second ribbon 94 one to the other, thereby providing visual cues that assist children in matching the first cooperating buckle member 102 with the second cooperating buckle member 112, thus enhancing and stimulating buckling and unbuckling skills.

In the preferred embodiment, as shown in FIG. 1, the unique matching indicia consist of a common ribbon pattern such as straight vertical line patterns, wavy vertical lines, straight horizontal line patterns, wavy horizontal lines and polka dot patterns. In alternate embodiments, the unique matching indicia may consist of a common ribbon color, common ribbon widths (FIG. 10), and common themes such as matching words of the same language, matching words from one or more languages that have substantially similar meanings, and matching words from one or more languages that are part of a phrase (as shown in some of the belts on FIG. 7). It is to be understood that the unique matching indicia may be any indicia capable of distinguishing each of the pair of ribbons 82 one from the other. One skilled in that will recognize that there are various indicia configurations available.

In one embodiment, each of the buckles 100 may have a buckle color that is visually distinguishable one from the other. In alternative embodiments, two or more of the buckles 100 have substantially similar buckle colors such that two or more of the buckles 100 are visually indistinguishable from each other by buckle color. One skilled in the art will recognize that there are various colors for buckles 100.

In one embodiment, each of the buckles 100 may have a buckle shape that is visually distinguishable one from the other. In alternative embodiments, two or more of the buckles 100 have substantially similar buckle shapes such that two or more of the buckles 100 are visually indistinguishable from each other by buckle shape. One skilled in the art will recognize that there are various shapes for buckles 100.

In one embodiment, each of the buckles 100 may be of a different buckle type such as an insert buckle type, a side release buckle type, a parachute buckle, a lift latch buckle and a push button buckle type, thus making each of buckles 100 visually distinguishable one from the other. In alternative embodiments, two or more of the buckles 100 are of substantially similar buckle types thus making two or more of the buckles 100 visually indistinguishable one from the other by buckle type. One skilled in the art will recognize that there are various types of buckles 100 available.

In an alternative embodiment, each of the belts 80 is distinguishable one from the other by a combination of buckle color, buckle type and buckle shape thereby providing additional visual cues that assist children in matching the first cooperating buckle member 102 with the second cooperating buckle member 112.

In the preferred embodiment, each of the buckles 100 is made of plastic. One skilled in the art will recognize that various materials can be used to make buckles 100.

In alternative embodiments, as shown in FIG. 5, one or more of said plurality of belts 80 is of sufficient length such that at least one of said pair of ribbons 82 is capable of extending on at least two distinct peripheries of the body 20 when the first cooperating buckle member 102 is attached to said second cooperating buckle member 112.

In the preferred embodiment, the body 20 has a head member 40 attached thereto. The head member 40 may comprise a head stuffing encased in a head skin. The head member 40 may be substantially circular in shape. In an alternative embodiment, the head member 40 may be triangular in shape. In the preferred embodiment, the head member 40 has a face portion 48 that resembles a face of an animal. The face portion 48 may be embroidered and may comprise one or more eye members 50, a nose member 52, a mouth member 54, and one or more ear members 56. The nose member 52 may be a plastic member covered by fabric. One skilled in the art will recognize that there are various shapes for heads and various methods for constructing a face portion 48. In the preferred embodiment, the widest portion of the head member 40 may be about 25 cm (approximately 10 inches), and the height of the head member 40 may be about 18 cm (approximately 7 inches).

In one embodiment, as shown in FIG. 2 and FIG. 3, the head member 40 contains a motion activated audio feedback device 66 such that movement of the head member 40 causes a sound to be emitted. In the preferred embodiment, the motion activated audio feedback device 66 is a moveable clapper surrounded by metal rods encased in a plastic shell that emits a chime sound. In alternative embodiments, the motion activated audio feedback device 66 emits a bell sound. One skilled in the art will recognize there are various ways to construct a motion activated feedback device 66 suitable of performing its intended purpose of emitting a sound when movement is detected, and various ways to construct a motion activated feedback device 66 that emits a variety of sounds.

The body 20 may have one or more arm members 60 affixed thereto. Each of the arm members 60 may comprise an arm stuffing encased in an arm skin. In the preferred embodiment, there are two arm members 60. In the preferred embodiment, each of the one or more arm members 60 is about 10 cm (approximately 4 inches) in length.

The body 20 may have one or more leg members 70 affixed thereto. Each of the leg members 70 may comprise a leg stuffing encased in a leg skin. In the preferred embodiment, there are two leg members 70. In the preferred embodiment, each of the one or more leg members 70 is about 5 cm (approximately 2 inches) in length.

In the preferred embodiment, the body 20 has a tail member 76 attached thereto. In alternative embodiments, as shown in FIG. 9 and FIG. 10, the head member 40 has whisker members 78 attached thereto. The whisker members 78 may be embroidered, or made from fishing line, yarn, horsehair, thread, or any other material capable of serving its intended purpose of attaching to the head member 40 and resembling whiskers of an animal such as without limitation a cat.

The applicant intends to encompass within the language any structure presently existing or developed in the future that performs the same function. In the claims, any means-plus-function clause is intended to cover the structures described herein as performing the recited function and, not only structural equivalents, but also equivalent structures. Other substitutions, modifications, changes and/or omissions may be made in the design, operating conditions and arrangement of the preferred and other exemplary embodiments without departing from the spirit of the present invention.

It is to be understood that the optimum dimensional relationships for the parts of the present invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1) An educational toy for facilitating development skills associated with buckling and unbuckling, said educational toy comprising:
(a) a body; and
(b) a plurality of belts, each comprising:
i) a pair of ribbons, each of said pair of ribbons comprising:
(1) a first ribbon having a first ribbon connecting end at one end that is attached to said body and a first ribbon buckle end at an opposite end; and
(2) a second ribbon having a second ribbon connecting end at one end that is attached to said body and a second ribbon buckle end at an opposite end;
ii) a buckle comprising:
(1) a first cooperating buckle member having a first cooperating buckle end that is attached to said first ribbon buckle end, and a first cooperating matching end at an opposite end; and
(2) a second cooperating buckle member having a second cooperating buckle end that is attached to said second ribbon buckle end, and a second cooperating matching end at an opposite end, said first cooperating buckle member and said second cooperating buckle member being releasably attachable one to the other, said first ribbon and said second ribbon forming a periphery about said body when said first cooperating buckle member and said second cooperating buckle member are attached one to the other; and
iii) each of said pair of ribbons having unique matching indicia such that said first ribbon and said second ribbon visually associate one to the other, said unique matching indicia differing from each of said pair of ribbons to each of said pair of ribbons such that each of said pair of ribbons is distinguishable one from the other, said unique matching indicia thus correlating said first cooperating buckle member and said second cooperating buckle member one to the other.

2) The educational toy in accordance with claim 1, wherein said unique matching indicia consists of common ribbon patterns, common ribbon colors, common ribbon widths, and common themes associated therewith.

3) The educational toy in accordance with claim 1, wherein one or more of said plurality of belts is of sufficient length such that at least one said pair of ribbons is capable of extending on at least two distinct peripheries of said body when said first cooperating buckle member is attached to said second cooperating buckle member.

4) The educational toy in accordance with claim 1, wherein said first ribbon connecting end and said second ribbon connecting end are non-specifically positioned in relation to each other.

5) The educational toy in accordance with claim 1, wherein a type of each of said plurality of said buckles has a buckle type, said buckle type selected from a group consisting of insert buckles, side release buckles, parachute buckles, lift latch buckles and push button buckles.

6) An educational toy in accordance with claim 1, wherein each of said plurality of buckles has a buckle color that is uniquely identifiable, one from the other.

7) An educational toy in accordance with claim 1, wherein:
(a) each of said plurality of buckles has a buckle color;
(b) each of said plurality of buckles has a buckle type;
(c) each of said plurality of buckles has a buckle shape; and
(d) each of said plurality of buckles is uniquely identifiable by a combination of said buckle color, said buckle type and said buckle shape.

8) The educational toy in accordance with claim 1, wherein there are three belts.

9) The educational toy in accordance with claim 1, wherein there are four belts.

10) The educational toy in accordance with claim 1, wherein there are five belts.

11) The educational toy in accordance with claim 1, wherein there are six belts.

12) The educational toy in accordance with claim 1, wherein a shape of said body is selected from a group consisting of a torso of a bear, a torso of a dog, a torso of a cat, a torso of a bunny, a cube, a round ball, and a football.

13) The educational toy in accordance with claim 1, wherein a shape of said body has a shape of a torso of an animal.

14) The educational toy in accordance with claim 1, further comprising a tail member affixed to said body.

15) The educational toy in accordance with claim 1, further comprising a head member affixed to said body.

16) The educational toy in accordance with claim 1, further comprising a head member affixed to said body, said head member containing a motion activated audio feedback device such that movement of said head member provides an audio feedback.

17) The educational toy in accordance with claim 1, further comprising a head member affixed to said body, said head member having whisker members attached thereto.

18) The educational toy in accordance with claim 1, further comprising a head member affixed to said body, said head member having a face that resembles a face of an animal.

19) The educational toy in accordance with claim 1, further comprising:
(a) one or more arm members affixed to said body;
(b) one or more leg members affixed to said body; and
(c) a head member affixed to said body, said head member containing a motion activated audio feedback device such that movement of said head member provides an audio feedback, said head member having a face portion that comprises:
i) one or more eye members affixed to said head member;
ii) one or more nose members affixed to said head member;
iii) one or more mouth members affixed to said head member; and
iv) one or more ear members affixed to said head member.

20) An educational toy for facilitating development skills associated with buckling and unbuckling, said educational toy comprising:
(a) a body having one or more seams;
(b) a plurality of body sections extending between each of said one or more seams; and
(c) a plurality of belts, each comprising:
i) a pair of ribbons, each of said pair of ribbons comprising:
(1) a first ribbon having a first ribbon connecting end at one end that is attached to one of said one or more seams, and a first ribbon buckle end at an opposite end; and
(2) a second ribbon having a second ribbon connecting end at one end that is attached to one of said plurality of seams, and a second ribbon buckle end at an opposite end;
ii) a buckle comprising:
(1) a first cooperating buckle member that has a first cooperating buckle end attached to said first ribbon buckle end, and a first cooperating matching end at an opposite end; and
(2) a second cooperating buckle member that has a second cooperating buckle end attached to said second ribbon buckle end, and a second cooperating matching end at an opposite end, said first cooperating buckle member and said second cooperating buckle member being releasably attachable one to the other, said first ribbon and said second ribbon forming a periphery about said body when said first cooperating buckle member and said second cooperating buckle member are attached one to the other; and
iii) each of said pair of ribbons having unique matching indicia such that said first ribbon and said second ribbon visually associate one to the other, said unique matching indicia differing from each of said pair of ribbons to each of said pair of ribbons such that each of said pair of ribbons is distinguishable one from the other, said unique matching indicia thus correlating said first cooperating buckle member and said second cooperating buckle member one to the other.
